(19) United States
(12) Patent Application Publication
(10) Pub. No.: US 2010/0139152 A1
(43) Pub. Date: Jun. 10, 2010

(54) HETEROGENEOUS CATALYSTS FOR MONO-ALKYL ESTER PRODUCTION, METHOD OF MAKING, AND METHOD OF USING SAME

(76) Inventors: Dennis Hucul, Midland, MI (US); Richard S. Shull, Midland, MI (US)

Correspondence Address: DINSMORE & SHOHL LLP, FIFTH THIRD CENTER, ONE SOUTH MAIN STREET, SUITE 1300, DAYTON, OH, 45402-2023, US

(21) Appl. No.: 12/632,474

(22) Filed: Dec. 7, 2009

Related U.S. Application Data
(60) Provisional application No. 61/120,595, filed on Dec. 8, 2008.

(51) Int. Cl. C10L 1/19; B01J 23/10; B01J 23/34

(52) U.S. Cl. 44/388; 502/304; 502/324

(57) ABSTRACT

A heterogeneous catalyst for use in esterification and/or transesterification reactions is provided having the formula AₓB₂₋ₓO₄₋ₓ, where x is between 0.25 and 1.2, A is selected from calcium, magnesium, strontium, or barium, and B is selected from manganese, cerium, titanium, zirconium, silicon, tin or germanium. The heterogeneous catalyst is formed by co-precipitating the corresponding nitrates of the catalyst materials with ammonium carbonate to form a precipitated product which is then calcined. The heterogeneous catalysts can be used to make mono-alkyl ester fuel from feedstocks containing waste oils, fats and grease in the presence of water and/or free fatty acids.

### CROSS-REFERENCE TO RELATED APPLICATIONS

This application claims the benefit of U.S. Provisional Application No. 61/120,595, filed Dec. 8, 2008, entitled HETEROGENEOUS CATALYSTS FOR MONO-ALKYL ESTER PRODUCTION, METHOD OF MAKING, AND METHOD OF USING SAME. The entire contents of said application is hereby incorporated by reference.

### BACKGROUND OF THE INVENTION

The present invention relates to heterogeneous catalysts for use in the production of mono-alkyl ester fuel from waste oils, fats, and grease, and more particularly, to a method of making heterogeneous catalysts which have a high surface area and which can be used in both esterification and transesterification reactions.

Mono-alkyl esters are a renewable diesel fuel which are typically produced by transesterification of highly refined vegetables oils (primarily composed of fatty acid tricylcerides) using an alcohol such as methanol and an alkaline catalyst such as sodium hydroxide, potassium hydroxide, or related alkoxides. Typically, homogeneous alkaline catalysts are used to promote the transesterification reaction. A transesterification reaction involves the process of exchanging the organic group of an ester with the organic group of an alcohol. However, such a reaction requires that the feedstock be comprised of refined oils containing not more than 0.5% free fatty acids because the use of alkaline catalysts promotes the formation of soaps that result in significantly reduced catalytic activity and produces emulsions of the mono-alkyl ester product (esters) and the by-product (glycerols), requiring a long settling time for separation. Further, alkaline catalysts need to be neutralized with mineral acids, which results in an impure glycerol co-product that requires an expensive purification procedure to produce a useable fuel.

While feedstocks containing free fatty acids can be used, the acids must first undergo an esterification reaction to transform the acids into esters. This is accomplished by reacting the free fatty acids in the presence of an alcohol using an acidic catalyst to form the corresponding ester of the fatty acid. However, this additional reaction produces water which must be removed from the ester product before transesterification can take place.

As the major factor determining the cost of mono-alkyl ester fuel is the price of refined oil feedstock, it has become more desirable to be able to use more economical feedstocks such as waste fats and oils, and to be able to produce fuels without additional reaction steps and/or refining operations.

Kawashima et al., “Development of heterogeneous base catalysts for biodiesel production,” Bioresource Technology 99 (2008) describe a process for producing heterogeneous base catalysts which can be used in the transesterification of oil. Some of the catalysts are prepared by milling together a mixture of a divalent oxide with calcium carbonate and then calcining at high temperatures (up to 1050° C.) to produce a finished catalyst. However, many of the catalysts prepared by the method of Kawashima et al. showed poor methyl ester yields after transesterification. Nakayama et al., U.S. Pat. No. 6,960,672, also describes the use of heterogeneous catalysts to produce alkyl esters from waste fats or oils. However, some of the catalyst preparations described in Nakayama et al. use sodium carbonate as a precipitating agent, which can often lead to undesirable leaching of sodium from the resulting catalyst.

Accordingly, there is a need in the art for heterogeneous catalysts which contribute to high yields when used in both transesterification and esterification reactions, and to an economical process for producing mono-alkyl ester fuels using such heterogeneous catalysts in combination with low cost feedstocks.

### SUMMARY

Embodiments of the present invention meet those needs by providing heterogeneous catalysts which are suitable for the production of mono-alkyl ester fuel from fats, oils and greases. The catalysts are unique in that they have a high surface area which improves yield, and can transform both free fatty acids and triglycerides into mono-alkyl esters suitable for use as fuels. The catalysts produce high quality esters and glycerol that can be easily and promptly separated, i.e., the glycerol produced does not require expensive refining operations.

According to one aspect of the present invention, a heterogeneous catalyst for use in esterification and/or transesterification reactions is provided having the formula AₓB₂₋ₓO₄₋ₓ, where x is between 0.25 and 1.2, A is selected from calcium, magnesium, strontium, or barium, and B is selected from manganese, cerium, titanium, zirconium, silicon, tin or germanium. The catalyst is in the form of particles having a surface area greater than 9.0 m²/g, and more preferably, from about 10 to about 140 m²/g. The particle size of the catalyst may vary from about 0.003 inches to about 0.5 inches in diameter (0.08 to 12.7 mm).

In one embodiment, the catalyst comprises calcium manganese oxide having a surface area of at least 15 m²/g, and preferably from about 25 m²/g to about 75 m²/g. In another embodiment, the catalyst comprises magnesium cerium oxide having a surface area of at least 15 m²/g, and preferably from about 70 m²/g to about 100 m²/g. In another embodiment, the catalyst comprises calcium cerium oxide having a surface area of at least 15 m²/g, and preferably from about 40 m²/g to about 75 m²/g.

A method of forming a heterogeneous catalyst for use in esterification and/or transesterification reactions is also provided, where the catalyst has the formula AₓB₂₋ₓO₄₋ₓ, where x is between 0.25 and 1.2, A is selected from calcium, magnesium, strontium, or barium, and B is selected from manganese, cerium, titanium, zirconium, silicon, tin or germanium. In one embodiment, the method comprises co-precipitating the corresponding nitrates of the catalyst materials with ammonium carbonate to form a precipitated product; and calcining the product preferably at a temperature between about 450° to 550° C. The co-precipitation preferably occurs at a pH of between about 4.0 and about 10.0. However, the calcining temperature and pH can vary from the preferred ranges noted above.

The method may include the optional step of adding a binder to the catalyst materials prior to co-precipitating, after precipitation, or after calcination. The binder preferably comprises from about 0.5 to about 30 wt % of the calcined catalyst, although greater or lesser amounts of the binder may be used. The resulting heterogeneous catalyst has a surface area greater than 9.0 m²/g, and preferably, from about 10 to about 140 m²/g.

In another embodiment, a method of converting fatty acids and/or triglycerides into mono-alkyl esters using a heterogeneous catalyst is provided, where the heterogeneous catalyst has the formula AₓB₂₋ₓO₄₋ₓ, where x is between 0.25 and 1.2, where A is selected from calcium, magnesium, strontium, or barium, and B is selected from manganese, cerium, titanium, zirconium, silicon, tin or germanium. The method comprises providing a feedstock selected from fats, oils, and greases, where the feedstock does not exclude the presence of water; and reacting the feedstock with an alcohol in the presence of the heterogeneous catalyst such that at least 95 mole % of the fatty acids and glycerides in the feedstock are converted into mono-alkyl esters, i.e., at least 95 mole % percent of the fatty acids and 95 mole % of the glycerides are converted into mono-alkyl esters, preferably their corresponding esters. By “corresponding esters,” we mean that the fatty acids are reacted with an alcohol to form the ester of the fatty acid and water. In one embodiment, at least 97 mole % of the fatty acids and glycerides in the feedstock are converted into mono-alkyl esters. The ratio (by mass) of the feedstock to methanol is from about 0.5:1 to about 4:1. The alcohol may be selected from methanol, ethanol, propanol or butanol. For alcohols other than methanol, the ratio by mass of feedstock to alcohol should be adjusted to maintain the same molar ratio.

The reaction preferably occurs at a temperature between about 100° C. to about 230° C., although temperatures outside of the preferred range may be used. The reaction may take place in a reactor such as a fixed bed reactor containing the catalyst. The resulting product may be used as a mono-alkyl ester fuel.

Accordingly, features of embodiments of the present invention provide a heterogeneous catalyst for use in esterification and/or transesterification reactions, a method of making the heterogeneous catalyst, and a method of using the heterogeneous catalyst to make a mono-alkyl ester fuel. These, and other features and advantages of the present invention, will become apparent from the following detailed description and the appended claims.

### DETAILED DESCRIPTION OF PREFERRED EMBODIMENTS

Embodiments of the heterogeneous catalysts of the present invention provide several advantages over prior methods of forming mono-alkyl ester fuels in that such catalysts can be used to make mono-alkyl ester fuel from feedstocks containing waste oils, fats and grease in the presence of water and/or free fatty acids. In addition, the method of making the catalysts results in catalysts having a high surface area which contributes to greatly improved yields (i.e., 90 mole % and greater) when used in transesterification and/or esterification reactions. Further, the method does not require numerous reaction steps or purification procedures to obtain a useable mono-alkyl ester product.

Unless otherwise indicated, all numbers expressing quantities of ingredients, properties such as molecular weight, reaction conditions, and so forth as used in the specification and claims are to be understood as being modified in all instances by the term “about.” Additionally, the disclosure of any ranges in the specification and claims, such as, for example, concentration ranges, temperature ranges, and pressure ranges are to be understood as including the range itself and also anything subsumed therein, as well as endpoints. Unless otherwise indicated, the numerical properties set forth in the specification and claims are approximations that may vary depending on the desired properties sought to be obtained in embodiments of the present invention. Notwithstanding that numerical ranges and parameters setting forth the broad scope of embodiments of the invention are approximations, the numerical values set forth in the specific examples are reported as precisely as possible. Any numerical values, however, inherently contain certain errors necessarily resulting from error found in their respective measurements.

The heterogeneous catalysts for use in the invention have the formula AₓB₂₋ₓO₄₋ₓ, where x is between 0.25 and 1.2, where A is selected from calcium, magnesium, strontium, or barium, and B is selected from manganese, cerium, titanium, zirconium, silicon, tin or germanium. The catalyst is in the form of particles having a surface area greater than 9.0 m²/g. The surface area may vary from about 10 to about 140 m²/g. The particle size of the catalyst may vary from about 0.003 to about 0.5 inches in diameter (0.08 to 12.7 mm), depending on the type of reactor used to form the mono-alkyl ester fuel and its configuration.

In the method of forming the heterogeneous catalyst, the corresponding nitrates of the catalyst materials are co-precipitated with ammonium carbonate to form a precipitated product. The co-precipitation preferably occurs at a pH of between about 4.0 and about 10.0, although the reaction may take place outside of the preferred pH range.

The formed product is then filtered, washed and preferably calcined at a temperature between about 450° C. to about 550° C., although the calcining temperature may take place outside of the preferred range. It should be appreciated that higher calcination temperatures may be used as long as adequate surface area is maintained. By maintaining the calcination temperature within this range, catalysts are obtained with a high surface area (i.e., greater than 9.0 m²/g) while still obtaining conversion of the precipitated carbonates to oxides.

Optionally, one or more binders may be added to the catalyst materials prior to co-precipitating to provide a catalyst which can be formed in a particular shape. Examples of suitable binders include organic binders, clays and silicas. Such binders may also be added after precipitation or after calcination.

In the method of forming a mono-alkyl ester fuel using the heterogeneous catalyst, a feedstock is provided which may comprise, for example, waste fats, oils, and greases. Examples of suitable feedstocks include extra virgin olive oil, canola oil, soybean oil, corn oil, palm oil, and mixtures thereof. The feedstock does not exclude the presence of water or free fatty acids. For example, feedstocks containing up to about 100 wt % free fatty acids which are saturated with water are acceptable. It should be appreciated that the amount of water will vary based on the particular combination of triglycerides and free fatty acids in the feedstock, but generally, any amount of dissolved water in the feedstock is acceptable.

The feedstock is reacted with an alcohol such as methanol, ethanol, propanol or butanol in the presence of the heterogeneous catalyst such that at least 95 mole % of the feedstock is converted into mono-alkyl esters, preferably corresponding esters. The (mass) ratio of the feedstock to methanol is from about 0.5:1 to about 4:1. However, it should be appreciated that increasing the amount of excess alcohol is acceptable for use in embodiments of the invention. The reaction preferably takes place at a temperature between about 100° C. to about 230° C., and may take place in, for example, a fixed bed reactor containing the catalyst. It should be appreciated that other types of reactors may also be used such as a packed bed reactor or a continuous stirred reactor. Where a fixed bed reactor is used, the feedstock may be combined with the alcohol and then fed, for example, by a liquid pump to the fixed bed reactor. The rate at which the feedstock is supplied may vary, depending on the volume of liquid feed and the volume of catalyst in the reactor.

It should be appreciated that the catalyst particles are re-useable. For example, after a reaction, the catalyst bed may be flushed with alcohols and/or solvents such as hexane. The catalyst particles may be repeatedly re-used.

In order that the invention may be more readily understood, reference is made to the following examples which are intended to illustrate embodiments of the invention, but not limit the scope thereof.

### Example 1

### Catalyst Synthesis

An aqueous solution was made by dissolving 36.2 g of magnesium nitrate hexahydrate [Mg(NO₃)₂(H₂O)₆] in about 75 ml of deionized water. A second solution was made by dissolving 61.3 g of cerium nitrate hexahydrate [Ce(NO₃)₃(H₂O)₆] in 75 ml of deionized water. After complete dissolution, these two solutions were mixed to form about 150 ml of mixed feed solution. Precipitation of this feed solution was carried out by adding it drop wise to a water bath where the pH was controlled to about 7.9 via the addition of an aqueous solution of ammonium carbonate. The addition took place over about a 15 minute time period and approximately 42 g of ammonium carbonate [(NH₄)₂CO₃] dissolved in 200 ml of water was used as the precipitating agent. After a short aging period, the precipitate that was formed was filtered from the solution, dried and then calcined to form a magnesium cerium oxide catalyst. After calcination, the BET surface area of this catalyst was 74 m²/g.

Calcination was carried out by placing the dried catalyst in a glass tube which was then inserted into a vertical tube furnace. A flow of air through the catalyst bed at about 100 cc/minute was started and temperature was increased to 500° C. This temperature and gas flow was maintained under these conditions for about two hours. After cooling, the catalyst was broken into small particles all about 1/16 inch (0.159 mm) or smaller in size.

### Example 2

An aqueous solution was made by dissolving 51.4 g of cerium nitrate hexahydrate [Ce(NO₃)₃(H₂O)₆] in about 125 ml of deionized water. A second solution was made by dissolving 31.1 g of calcium nitrate tetrahydrate [Ca(NO₃)₂(H₂O)₄] in 100 ml of deionized water. After complete dissolution, these two solutions were mixed to form about 200 ml of mixed feed solution. Precipitation of this feed solution was carried out by adding it drop wise to a water bath where the pH was controlled to about 7.9 via the addition of an aqueous solution of ammonium carbonate. The addition took place over about a 15 minute time period and approximately 42 g of ammonium carbonate [(NH₄)₂CO₃] dissolved in 200 ml of water was used as the precipitating agent. After a short aging period, the precipitate that was formed was filtered from the solution, dried and then finally calcined to form a calcium cerium oxide catalyst. The calcination procedure described in Example 1 was used. After calcination, the BET surface area of this catalyst was 44 m²/g.

### Example 3

An aqueous solution was made by dissolving 47.4 g of manganese nitrate tetrahydrate [Mn(NO₃)₂(H₂O)₄] in about 100 ml of deionized water. A second solution was made by dissolving 49.6 g of calcium nitrate tetrahydrate [Ca(NO₃)₂(H₂O)₄] in 100 ml of deionized water. After complete dissolution, these two solutions were mixed to form about 200 ml of mixed feed solution. Precipitation of this feed solution was carried out by adding it drop wise to a water bath where the pH was controlled to about 7.9 via the addition of an aqueous solution of ammonium carbonate. The addition took place over about a 15 minute time period and approximately 48 g of ammonium carbonate [(NH₄)₂CO₃] dissolved in 200 ml of water was used as the precipitating agent. After a short aging period, the precipitate that was formed was filtered from the solution, dried and then calcined as described in Example 1 to form a calcium manganese oxide catalyst. After calcination, the BET surface area of this catalyst was 27 m²/g.

### Comparative Example 4

A feedstock containing 85% by weight commercial food grade extra-virgin olive oil and 15% octanoic acid was prepared. The feedstock and methanol were fed via two pumps in a feedstock-to-alcohol volume ratio of 2.03:1 into a fixed bed reactor containing a calcium zirconium oxide catalyst. The particle size of the catalyst ranged from powder to #10 mesh. The catalyst BET surface area was 6.3 m²/g. The liquid space velocity was 1.2. Samples were taken for analysis after the reactor reached steady state. At 180° C., the conversion of glycerides to methyl esters was greater than 57 mole %, and the conversion of octanoic acid was greater than 90 mole %. At 206° C. the conversion of glycerides to methyl esters was greater than 84 mole %, and the conversion of octanoic acid was greater than 86 mole %.

### Example 5

A feedstock containing 85% by weight commercial food grade extra-virgin olive oil and 15% octanoic acid was prepared. The feedstock and methanol were fed via two pumps in a feedstock-to-alcohol volume ratio of 2.03:1 into a fixed bed reactor containing a calcium cerium oxide catalyst. The particle size of the catalyst ranged from powder to #10 mesh. The catalyst BET surface area was 43.7 m²/g. The liquid space velocity was 1.2. Samples were taken for analysis after the reactor reached steady state. At 180° C., the conversion of glycerides to methyl esters was greater than 97 mole %, and the conversion of octanoic acid was greater than 92 mole %. At 206° C., the conversion of glycerides to methyl esters was greater than 98 mole %, and the conversion of octanoic acid was greater than 93 mole %.

### Example 6

A feedstock containing 85% by weight commercial food-grade peanut oil and 15% octanoic acid was prepared. The feedstock and methanol were fed via two pumps in a feedstock-to-alcohol volume ratio of 2.03:1 into a fixed bed reactor containing a calcium manganese oxide catalyst. The particle size of the catalyst ranged from powder to #10 mesh. The catalyst BET surface area was 26.6 m²/g. The liquid space velocity was 1.2. Samples were taken for analysis after the reactor reached steady state. At 180° C., the conversion of glycerides to methyl esters was greater than 98 mole % and the conversion of octanoic acid was greater than 97 mole %. At 206° C. the conversion of glycerides to methyl esters was greater than 98 mole %, and the conversion of octanoic acid was greater than 95 mole %.

### Example 7

A feedstock containing 85% by weight commercial food-grade peanut oil and 15% octanoic acid was prepared. The feedstock and methanol were fed via two pumps in a feedstock-to-alcohol volume ratio of 2.03:1 into a fixed bed reactor containing a calcium cerium oxide catalyst. The particle size of the catalyst ranged from powder to #10 mesh. The catalyst BET surface area was 43.7 m²/g. The liquid space velocity was 1.2. Samples were taken for analysis after the reactor reached steady state. At 180° C. the conversion of glycerides to methyl esters was greater than 91 mole %, and the conversion of octanoic acid was greater than 94 mole %. At 207° C., the conversion of glycerides to methyl esters was greater than 98 mole %, and the conversion of octanoic acid was greater than 94 mole %.

### Example 8

A feedstock containing 85% by weight commercial food-grade corn oil and 15% octanoic acid was prepared. The feedstock and methanol were fed via two pumps in a feedstock-to-alcohol volume ratio of 2.03:1 into a fixed bed reactor containing a calcium manganese oxide catalyst. The particle size of the catalyst ranged from powder to #10 mesh. The catalyst BET surface area was 26.6 m²/g. The liquid space velocity was 1.2. Samples were taken for analysis after the reactor reached steady state. At 180° C., the conversion of glycerides to methyl esters was greater than 88 mole % and the conversion of octanoic acid was greater than 82 mole %. At 206° C., the conversion of glycerides to methyl esters was greater than 98 mole % and the conversion of octanoic acid was greater than 94 mole %.

### Example 9

A feedstock containing 85% by weight commercial food-grade corn oil and 15% octanoic acid was prepared. The feedstock and methanol were fed via two pumps in a feedstock-to-alcohol volume ratio of 2.03:1 into a fixed bed reactor containing a calcium cerium oxide catalyst. The particle size of the catalyst ranged from powder to #10 mesh. The catalyst BET surface area was 43.7 m²/g. The liquid space velocity was 1.2. Samples were taken for analysis after the reactor reached steady state. At 206° C., the conversion of glycerides to methyl esters was greater than 98 mole % and the conversion of octanoic acid was greater than 94 mole %.

### Example 10

A feedstock containing 85% by weight commercial food-grade canola oil and 15% octanoic acid was prepared. The feedstock and methanol were fed via two pumps in a feedstock-to-alcohol volume ratio of 2.03:1 into a fixed bed reactor containing a calcium manganese oxide catalyst. The particle size of the catalyst ranged from powder to #10 mesh. The catalyst BET surface area was 26.6 m²/g. The liquid space velocity was 1.2. Samples were taken for analysis after the reactor reached steady state. At 179° C. the conversion of glycerides to methyl esters was greater than 84 mole % and the conversion of octanoic acid was greater than 82 mole %. At 206° C. the conversion of glycerides to methyl esters was greater than 97 mole % and the conversion of octanoic acid was greater than 93 mole %.

### Example 11

A feedstock containing 85% by weight commercial food-grade extra-virgin olive oil and 15% octanoic acid was prepared. The feedstock and methanol were fed via two pumps in a feedstock-to-alcohol volume ratio of 2.03:1 into a fixed bed reactor containing a magnesium manganese oxide catalyst. The particle size of the catalyst ranged from powder to #10 mesh. The liquid space velocity was 1.2. Samples were taken for analysis after the reactor reached steady state. At 180° C. the conversion of glycerides to methyl esters was greater than 94 mole % and the conversion of octanoic acid was greater than 86 mole %.

### Example 12

A feedstock containing 85% by weight commercial food grade extra-virgin olive oil and 15% octanoic acid was prepared. The feedstock and methanol were fed via two pumps in a feedstock-to-alcohol volume ratio of 2.03:1 into a fixed bed reactor containing a barium cerium oxide catalyst. The particle size of the catalyst ranged from powder to #10 mesh. The liquid space velocity was 1.2. Samples were taken for analysis after the reactor reached steady state. At 180° C. the conversion of glycerides to methyl esters was greater than 80 mole % and the conversion of octanoic acid was greater than 97 mole %. At 206° C. the conversion of glycerides to methyl esters was greater than 91 mole % and the conversion of octanoic acid was greater than 97 mole %.

### Example 13

A feedstock containing 85% by weight commercial food grade extra-virgin olive oil and 15% octanoic acid was prepared. The feedstock and methanol were fed via two pumps in a feedstock-to-alcohol volume ratio of 2.03:1 into a fixed bed reactor containing a strontium cerium oxide catalyst. The particle size of the catalyst ranged from powder to #10 mesh. The liquid space velocity was 1.2. Samples were taken for analysis after the reactor reached steady state. At 180° C. the conversion of glycerides to methyl esters was greater than 85 mole % and the conversion of octanoic acid was greater than 97 mole %. At 208° C. the conversion of glycerides to methyl esters was greater than 98 mole % and the conversion of octanoic acid was greater than 97 mole %.

### Example 14

A feedstock containing 85% by weight commercial food grade extra-virgin olive oil and 15% octanoic acid was prepared. The feedstock and methanol were fed via two pumps in a feedstock-to-alcohol volume ratio of 2.03:1 into a fixed bed reactor containing a strontium manganese oxide catalyst. The particle size of the catalyst ranged from powder to #10 mesh. The liquid space velocity was 1.2. Samples were taken for analysis after the reactor reached steady state. At 180° C. the conversion of glycerides to methyl esters was greater than 97 mole % and the conversion of octanoic acid was greater than 97 mole %. At 208° C. the conversion of glycerides to methyl esters was greater than 97 mole % and the conversion of octanoic acid was greater than 97 mole %.

### Example 15

A feedstock containing 85% by weight commercial food grade extra-virgin olive oil and 15% octanoic acid was prepared. The feedstock and methanol were fed via two pumps in a feedstock-to-alcohol volume ratio of 2.03:1 into a fixed bed reactor containing a calcium manganese oxide catalyst. The particle size of the catalyst ranged from powder to #10 mesh. The catalyst BET surface area was 26.6 m²/g. The liquid space velocity was 1.2. Samples were taken for analysis after the reactor reached steady state. At 180° C. the conversion of glycerides to methyl esters was greater than 94% and the conversion of octanoic acid was greater than 97%. At 206° C. the conversion of glycerides to methyl esters was greater than 98% and the conversion of octanoic acid was greater than 97%.

### Example 16

A feedstock containing 85% by weight commercial food grade extra-virgin olive oil and 15% octanoic acid was prepared. The olive oil and octanoic acid feedstock mixture was agitated in the presence of water to saturate the mixture with water. The excess water was decanted off. The remaining water-saturated feedstock mixture and methanol were fed via two pumps in a feedstock-to-alcohol volume ratio of 1.15:1 into a fixed bed reactor containing a magnesium cerium oxide catalyst. The particle size of the catalyst ranged from powder to #10 mesh. The catalyst BET surface area was 73.8 m²/g. The liquid space velocity was 1.2. Samples were taken for analysis after the reactor reached steady state. At 180° C. the conversion of glycerides to methyl esters was greater than 76 mole % and the conversion of octanoic acid was greater than 97 mole %. At 206° C. the conversion of glycerides to methyl esters was greater than 96 mole % and the conversion of octanoic acid was greater than 97 mole %.

### Example 17

A feedstock containing 85% by weight commercial food grade extra-virgin olive oil and 15% octanoic acid was prepared. The feedstock and ethanol were fed via two pumps in a feedstock-to-alcohol volume ratio of 0.80:1 into a fixed bed reactor containing a magnesium cerium oxide catalyst. The particle size of the catalyst ranged from powder to #10 mesh. The catalyst BET surface area was 73.8 m²/g. The liquid space velocity was 1.23. Samples were taken for analysis after the reactor reached steady state. At 180° C. the conversion of glycerides to ethyl esters was greater than 64 mole % and the conversion of octanoic acid was greater than 97 mole %. At 206° C., the conversion of glycerides to ethyl esters was greater than 94 mole % and the conversion of octanoic acid was greater than 96 mole %.

### Example 18

A feedstock containing 85% by weight commercial food grade extra-virgin olive oil and 15% octanoic acid was prepared. The feedstock and 1-butanol were fed via two pumps in a feedstock-to-alcohol volume ratio of 0.52:1 into a fixed bed reactor containing a magnesium cerium oxide catalyst. The particle size of the catalyst ranged from powder to #10 mesh. The catalyst BET surface area was 73.8 m²/g. The liquid space velocity was 1.23. Samples were taken for analysis after the reactor reached steady state. At 180° C. the conversion of glycerides to butyl esters was greater than 53 mole % and the conversion of octanoic acid was greater than 97 mole %. At 207° C. the conversion of glycerides to butyl esters was greater than 91 mole % and the conversion of octanoic acid was greater than 97 mole %.

### Example 19

A feedstock containing 100% commercial yellow grease was prepared. The feedstock and methanol were fed via two pumps in a feedstock-to-alcohol volume ratio of 1.15:1 into a fixed bed reactor containing a magnesium cerium oxide catalyst. The particle size of the catalyst ranged from powder to #10 mesh. The catalyst BET surface area was 73.8 m²/g. The liquid space velocity was 1.2. The reactor was allowed to run continuously for 61.5 hours at 206° C. The conversion of glycerides to methyl esters was greater than 99 mole % throughout the entire run.

Having described the invention in detail and by reference to preferred embodiments thereof, it will be apparent that modifications and variations are possible without departing from the scope of the invention.

What is claimed is:

1. A heterogeneous catalyst for use in esterification and/or transesterification reactions having the formula AₓB₂₋ₓO₄₋ₓ, where x is between 0.25 and 1.2, A is selected from calcium, magnesium, strontium, or barium, and B is selected from manganese, cerium, titanium, zirconium, silicon, tin or germanium; said catalyst being in the form of particles having a surface area greater than 9.0 m²/g.

2. The catalyst of claim 1 comprising calcium manganese oxide having a surface area of at least 15 m²/g.

3. The catalyst of claim 1 comprising magnesium cerium oxide having a surface area of at least 15 m²/g.

4. The catalyst of claim 1 comprising calcium cerium oxide having a surface area of at least 15 m²/g.

5. The catalyst of claim 1 having a surface area of from about 10 to about 140 m²/g.

6. A method of forming a heterogeneous catalyst for use in esterification and/or transesterification reactions having the formula AₓB₂₋ₓO₄₋ₓ, where x is between 0.25 and 1.2, A is selected from the group consisting of calcium, magnesium, strontium, or barium, and B is selected from the group consisting of manganese, cerium, titanium, zirconium, silicon, tin or germanium, said method comprising:
co-precipitating the corresponding nitrates of said catalyst materials with ammonium carbonate to form a precipitated product; and
calcining said product.

7. The method of claim 6 wherein said product is calcined at a temperature between about 450° C. to about 550° C.

8. The method of claim 6 wherein said co-precipitation occurs at a pH of between about 4.0 and about 10.0.

9. The method of claim 6 including adding a binder to said catalyst materials prior to co-precipitating.

10. The method of claim 6 including adding a binder to said precipitated product prior to calcining.

11. The method of claim 6 including adding a binder to said precipitated product after calcining.

12. The method of claim 6 wherein said heterogeneous catalyst has a surface area greater than 9.0 m²/g.

13. The method of claim 6 wherein said heterogeneous catalyst has a surface area of from about 10 to about 140 m²/g.

14. A method of converting fatty acids and/or triglycerides into mono-alkyl esters using a heterogeneous catalyst having the formula AₓB₂₋ₓO₄₋ₓ, where x is between 0.25 and 1.2, A is selected from the group consisting of calcium, magnesium, strontium, or barium, and B is selected from the group consisting of manganese, cerium, titanium, zirconium, silicon, tin or germanium; said catalyst being in the form of particles having a surface area greater than 9.0 m²/g, said method comprising:
providing a feedstock selected from the group consisting of fats, oils, and greases, wherein said feedstock does not exclude the presence of water; and
reacting said feedstock with an alcohol in the presence of said heterogeneous catalyst such that at least 90 mole % of the free fatty acids and glycerides in said feedstock are converted into mono-alkyl esters.

15. The method of claim 14 wherein said alcohol is selected from the group consisting of methanol, ethanol, propanol, and butanol.

16. The method of claim 14 wherein said reaction occurs at a temperature between about 100° C. to about 230° C.

17. The method of claim 14 wherein the mass ratio of said feedstock to said alcohol is from about 0.5:1 to about 4:1.

18. The method of claim 14 wherein said reaction takes place in a fixed bed reactor containing said catalyst.

19. The method of claim 14 wherein at least 95 mole % of the free fatty acids and glycerides in said feedstock are converted into mono-alkyl esters.

20. The method of claim 14 wherein at least 97 mole % of the free fatty acids and glycerides in said feedstock are converted into mono-alkyl esters.

21. The method of claim 14 wherein said heterogeneous catalyst has a surface area of from about 10 to about 140 m²/g.

22. A mono-alkyl ester fuel formed by the method of claim 14.
